(19) United States
(12) Patent Application Publication
(10) Pub. No.: US 2021/0047245 A1
(43) Pub. Date: Feb. 18, 2021

(54) An Aerobic Composting Apparatus

(71) Applicant: GEC INTEGRATION SDN BHD, PERAI (MY)

(72) Inventor: Kean Hoe Wong, BUTTERWORTH (MY)

(21) Appl. No.: 16/978,893

(22) PCT Filed: Feb. 27, 2019
(86) PCT No.: PCT/MY19/50015

§ 371 Date: Sep. 8, 2020

(30) Foreign Application Priority Data
Mar. 8, 2018 (MY) PI 2018700916

(51) Int. Cl. C05F 17/979; C05F 17/60; C05F 17/70; C05F 17/40

(52) U.S. Cl. CPC C05F 17/979; C05F 17/40; C05F 17/70; C05F 17/60

(57) ABSTRACT

The present invention relates to an apparatus (100) for performing aerobic composting of organic waste comprising an air-tight vessel (20) for receiving the organic waste and composting the waste with thermophilic bacteria; an air circulating means (16) for generating low air pressure within the vessel (20) and providing oxygen supply to the thermophilic bacteria; and a heating means (19) for generating heat to the vessel (20).

### FIELD OF INVENTION

The present invention relates to a composting apparatus and particularly to an apparatus for performing aerobic composition of organic waste.

### BACKGROUND OF THE INVENTION

Microbes have long been employed in composting system to ferment organic waste such as kitchen waste, garden waste, animal manure and waste water sludge to form compost. While the noxious organic waste is eliminated via the decomposition process, the composted organic material obtained can be used as soil conditioner or fertilizer. Nevertheless, the composting process using microbes consume a long period of time in order to produce compost product of desirable quality.

Various systems have been designed to perform in-vessel decomposition of the organic waste, but these systems have been generally focused on stabilizing the compost. Although the stability of the final product is significantly increased, this accomplishment is however achieved at the expense of increased time required to complete the decomposition process. Thus, it is desirable to develop an apparatus that can accelerate the decomposition process employing the microorganisms while also producing innocuous product.

Besides, stickiness of sludge remains a problem to be tackled for an in-vessel decomposition system. Sludge containing moisture level of up to 40% to 80% can easily form lump or stick to the wall of the vessel during the decomposition process in the vessel. This often induces the waste to stay underheated and wet for a substantial period of time. Moreover, the process of decomposition is further deterred due to insufficient of aeration as a result of the formation of lump. It is therefore desirable to provide an apparatus that can overcome the abovementioned problems.

SUMMARY OF INVENTION

The main aspect of the present invention is to provide a composting apparatus that can accelerate the decomposition process of organic waste.

Another aspect of the present invention is to provide a composting apparatus that could effectively convert the organic waste into useful compost with the elimination of bad odour, leachate and greenhouse gas.

Still another aspect of the present invention is to provide a composting apparatus that enables efficient drying of the compost by providing a low air pressure condition in the vessel to lower down the boiling point of water to below 90° C.

Yet another aspect of the present invention is to provide a composting apparatus that incorporate the use of ceramic or clay pebble to reduce the stickiness of sludge waste in order to provide better condition for aeration and drying.

At least one of the preceding aspects is met, in whole or in part, by the present invention, in which the embodiment of the present invention describes an apparatus (100) for performing aerobic composting of organic waste comprising an air-tight vessel (20) for receiving the organic waste and composting the waste with thermophilic bacteria; an air circulating means (16) for generating low air pressure within the vessel (20) and providing oxygen supply to the thermophilic bacteria; and a heating means (19) for generating heat to the vessel (20).

Preferably, the heating means (19) is a heater plate installed at the bottom wall of the vessel (20).

According to a preferred embodiment, the apparatus (100) further comprising a thermocouple (18) attached at the bottom wall of the vessel (20) for maintaining the temperature in the vessel (20) within the range of 75-125° C.

In another preferred embodiment, the apparatus (100) further comprising an air inlet (22) for feeding the air into the vessel (20). It is also preferable that the apparatus (100) further comprising an air outlet for discharging the air out of the vessel (20).

Still another preferred embodiment, the apparatus (100) further comprising a controlling means (5) for regulating air pressure and temperature within the vessel (20).

In yet another preferred embodiment, the apparatus (100) further comprising a condensing unit (9) for condensing water vapor released from the composting waste.

Again another preferred embodiment discloses that the apparatus (100) further comprising an agitating means (23) to agitate the composting waste. Preferably, the agitating means (23) is a horizontal agitator within the vessel (20).

Preferably, the vessel (20) comprises clay, ceramic pebble or a mixture thereof to bind with the composting waste to form sludge.

The present preferred embodiment of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows a sectional front view of the apparatus (100) according to one of the preferred embodiment.

FIG. 2 shows the air circulating system of the apparatus (100) according to one of the preferred embodiment.

FIG. 3 shows the heating system of the apparatus (100) according to one of the preferred embodiment.

FIG. 4 shows the condensing system of the apparatus (100) according to one of the preferred embodiment.

FIG. 5 shows the agitation system of the apparatus (100) according to one of the preferred embodiment.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention relates to an apparatus (100) for performing aerobic composting of organic waste comprising an air-tight vessel (20) for receiving the organic waste and composting the waste with thermophilic bacteria; an air circulating means (16) for generating low air pressure within the vessel (20) and providing oxygen supply to the thermophilic bacteria; and a heating means (19) for generating heat to the vessel (20).

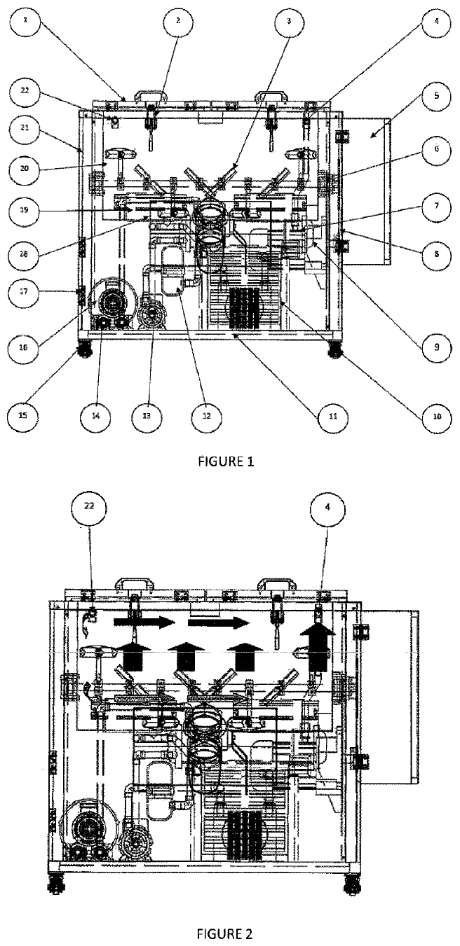

Referring to FIG. 1, the air tight vessel (20) is preferably installed onto a supporting base (11). The vessel (20) is preferably sealed with at least one air tight hatch (1) mounted on top of the vessel (20). In one preferred embodiment, the hatch (1) is installed on top of an outer cover (21) above the vessel (20). Preferably, the hatch (1) is fastened with a latch (2).

According to the present invention, the decomposition process of the organic waste is preferably conducted under a low air pressure condition. The advantage of providing a low air pressure condition is to lower down the boiling point of water in order to accelerate the removal of water content from the waste. Preferably, the boiling point of water is lowered down to about 85-90° C. Therefore, it is preferable that the air tight vessel (20) is designed for low interior air pressure. Preferably, the vessel (20) is optimized for an air pressure range from about ?? psi to about ?? psi.

In order to provide a low air pressure condition in the interior of the vessel, it is preferable that an air circulating means (16) is installed in the apparatus (100). The air circulating means is preferably an air blower (16) to continuously circulate air within the vessel. As illustrated in FIG. 2, the air is preferably fed into the vessel (20) by the air blower (16) through an air inlet (22) and discharged out of the vessel (20) through an air outlet (4). The continuous movement of air into and out of the composting vessel (20) is able to create a low air pressure condition within the vessel (20). Besides, the air generated by the air blower (16) provides sufficient aeration to the bacteria to perform aerobic fermentation of the organic waste in the vessel (20).

FIG. 3 shows a heating means (19) of the apparatus (100) according to one of the preferred embodiment. Preferably, the heating means (19) is provided in the form of a heater plate or a hot oil jacket mounted at the bottom wall of the vessel (20). It is preferable that a thermocouple (18) is mounted at the bottom of the vessel (20) in order to regulate the temperature of the vessel (20) that is suitable for the growth of the thermophilic bacteria. In the preferred embodiment, the temperature of the vessel (20) is regulated at a temperature ranged from 75° C. to 125° C. Moreover, by heating the vessel (20), a heat difference between the air at the interior and the exterior of the vessel (20) is created. Hence, during the operation of the apparatus (100) as shown in FIG. 2, the hot moist air will shift from the bottom to the top of the vessel and be discharged through the air outlet (4), whereas the cool air from the exterior of the vessel (20) will enter through the air inlet (22) and replace the hot moist air at the bottom of the vessel to supply oxygen to the aerobic fermentation of the organic waste.

Preferably, the air pressure and the temperature within the vessel (20) is regulated via a controlling means (5).

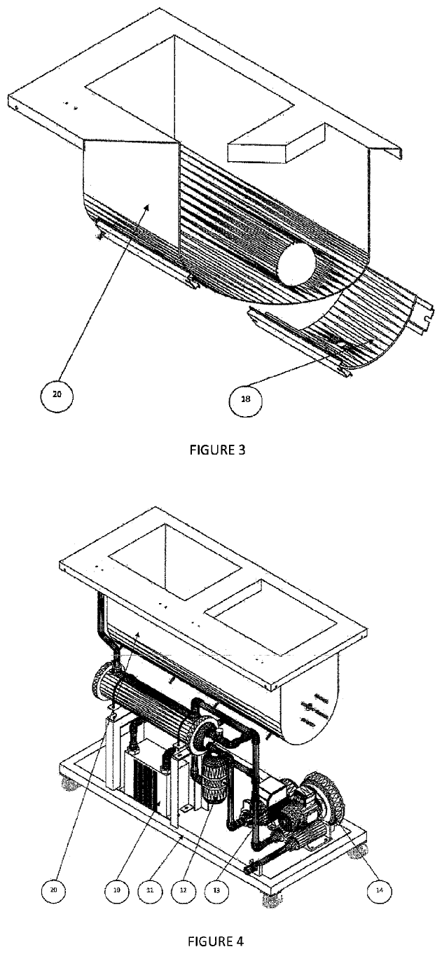

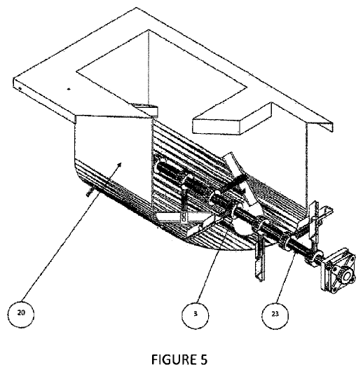

As shown in FIG. 4, the apparatus (100) further comprising a condensing unit (9) in order to condense the water vapor released from the decomposition process of the organic waste. Preferably, the condensing unit (9) is installed on top of the supporting base (11). Preferably, the condensation of the water vapor is further assisted by a cooling coil (10). The condensed water is then preferably discharged into a water discharge unit (12). In a preferred embodiment, a water pump (13) is preferably installed in the apparatus (100) to circulate water in order to cool the condensing unit (9) and the cooling coil (10).

Pursuant to a preferred embodiment, the apparatus (100) further comprising an agitator means (23) to agitate the composting waste. Preferably, the agitator means is a horizontal agitator with a plurality of mixer blade (3) within the vessel (20). It is preferable that the horizontal agitator is driven by a roller chain and sprocket system (8) coupled with an induction motor (7). The purpose of agitation is to improve aeration in the composting waste in order to enhance efficiency of the fermentation process carried out by the thermophilic bacteria.

Further, it is preferable that ceramic, clay pebbles or a mixture thereof is added into the vessel (20) as additive. The additive is preferably used especially when sludge waste with moisture level of about 40-80% is subjected to decomposition using the apparatus (100) of the present invention. Preferably, the ceramic and clay pebbles used in the present invention are porous and not abrasive to the surface of the vessel (20). By providing the ceramic and clay pebbles in the vessel (20), the sludge will hind the surface thereof and thereby reducing the stickiness of the sludge to the wall surface of the vessel (20) as well as preventing the formation of lump. Besides, the porous ceramic and clay pebbles can also serve as a good habitat for the growth of the bacteria.

It will be appreciated by the person in the art that the apparatus (100) of the present invention enable faster and more efficient decomposition of organic waste material by the bacteria. In a preferred embodiment, the decomposition process can be accomplished within about 24 hours. The final product generated using the apparatus (100) of the present invention is an innocuous compost with a low moisture content, which enable user to easily remove it from the vessel (20). The compost produced is preferably suitable to be used as fertilizer or soil conditioner.

Although the invention has been described and illustrated in detail, it is to be understood that the same is by the way of illustration and example, and is not to be taken by way of limitation. The spirit and scope of the present invention are to be limited only by the terms of the appended claims.

1.-10. (canceled)

11. An apparatus for performing aerobic composting of organic waste, comprising:
an air-tight vessel having an air inlet that is positioned at a portion of the vessel that allows air flow within the vessel, and an air outlet that is positioned on a top portion of the vessel, for receiving the organic waste and composting the waste with thermophilic bacteria;
an air circulating means to feed air into the vessel for generating low air pressure within the vessel and providing oxygen supply to the thermophilic bacteria; and
a heating means provided at a bottom wall of the vessel for generating heat and heating the waste to the vessel to maintain a temperature range of 75-125° C.;
wherein heat generated to the vessel under the low air pressure within the vessel is created by creating a continuous air movement of air into and out of the vessel that is attained by allowing cool air to flow into the vessel through the air inlet and hot moist air to flow out of the vessel through the air outlet flows in and out of the vessel for providing an oxygen supply to the thermophilic bacteria.

12. The apparatus according to claim 11, further comprising:
a thermocouple attached at the bottom wall of the vessel for maintaining the temperature in the vessel within the range of 75-125° C.

13. The apparatus according to claim 11, further comprising:
a controlling means for regulating air pressure and temperature within the vessel.

14. The apparatus according to claim 11, further comprising:
a condensing unit for condensing water vapor released from the composting waste.

15. The apparatus according to claim 11, wherein the vessel comprises clay, ceramic pebble or a mixture thereof to bind with the composting waste to form sludge.

16. The apparatus according to claim 11, wherein the heating means is a heater plate installed at the bottom wall of the vessel.

17. The apparatus according to claim 11, further comprising:
an agitating means to agitate the composting waste.

18. The apparatus according to claim 17, wherein the agitating means is a horizontal agitator within the vessel.
